(19) United States
(12) Patent Application Publication
(10) Pub. No.: US 2016/0026078 A1
(43) Pub. Date: Jan. 28, 2016

(54) EDGE-FREE FIXED FRAME PROJECTION SCREEN

(71) Applicant: ELITE SCREENS, INC., Garden Grove, CA (US)

(72) Inventors: Zhang Qingjun, Shenzhen (CN); Jiang Gengyuan, Shenzhen (CN); Zhu Jing, Shenzhen (CN)

(21) Appl. No.: 14/341,716

(22) Filed: Jul. 25, 2014

(51) Int. Cl. G03B 21/56

(52) U.S. Cl. CPC G03B 21/56

(57) ABSTRACT

A projection screen assembly, comprising a screen having a front surface and a back surface, a frame assembly and a mounting assembly. The frame assembly includes a pair of horizontal frame members, a pair of vertical frame members and a support bar. Each of the pair of horizontal frame members connected to the pair of vertical frame members by means of a plurality of connecting means and a plurality of tightening means. The frame assembly includes an outer surface and an inner surface having a channel adaptable to receive a fastening means. The mounting assembly having a plurality of brackets and a plurality of attachment means. The screen positioned over the frame assembly provides a frameless projection screen assembly that allows the use of multiple projection screen assembly without any gap therebetween and providing a thin bezel look.

### BACKGROUND OF THE DISCLOSURE

1. Technical Field of the Disclosure

The present embodiment is related in general to projection screens, and in particular to an edge free fixed frame projection screen and a method of constructing the projection screen that avoids puncturing of the screen and provides a thin bezel look.

2. Description of the Related Art

A projection screen is a large reflective surface, that's typically hung on a wall in a room at some distance in front of any type of digital or film projector for the purposes of entertainment, training, education or a sales presentation. Compared to a bare wall, a projection screen affords higher reflectivity, resulting in a brighter picture. A screen also bestows a more uniform image surface and truer color rendition. A projection screen reproduces an image without losing quality, by maximizing the light coming from a projector and reflecting it so that everyone in front of the screen can see the image clearly. Both the projector and projection screen need to match the size and purpose of the room.

The installation of a projection screen consisting of a screen attached with a support structure for displaying a projected image. The screen may be permanently installed as in a movie theater, painted on the wall, semi-permanent or mobile, as in a conference room or other non-dedicated viewing space. Uniformly white or grey screens are used almost exclusively to avoid any discoloration of the image. The most desired brightness of the screen depends on a number of variables, such as the ambient light level and the luminous power of the projector. Flat or curved screens may be used depending on the optics used to project the image, and the desired geometrical accuracy of the image production, flat screens being the more common of the two. Screens can be further designed for front or back projection, the more common front projection systems having the image source situated on the same side of the screen as the audience.

One existing projection screen provides a frame assembly used to mount a screen. The frame assembly includes screen-perimeter members and frame-splice members. The splice members permit the perimeter members to be separated into segments. However, such a projection screen will be of large size and the awkward shape of projection screen systems makes them difficult to transport and set up.

Another existing projection screen discloses a rotatable screen which can be mounted along the lower ends of its sides by brads to vertical support arms. The upper portion of the screen is fastened to a cord which allows for the adjustment of the screen by loosening or tightening the cord. Vertical adjustment of the screen is provided by spaced pairs of slots in the vertical support arms, attached to supporting wall hooks. Another existing projection screen discloses a reconfigurable projection-screen system. The projection-screen system includes a flexible screen and a frame assembly. The flexible screen includes a screen perimeter and a viewing region within the screen perimeter. The frame assembly includes a plurality of frame members, where at least some of the frame members include a screen perimeter engaging portion. The frame members are selectively arranged for an assembled viewing configuration and a disassembled configuration. However, such projection screens do not provide a supporting structure which remains hidden from view to maintain a pleasing aesthetic appearance to the viewer.

In light of the foregoing, there is a need for an improved projection screen that would be adaptable to provide a frame assembly which may be selectively assembled and disassembled in a simple and cost effective manner for ease of shipping, storage, and set up. Such a needed projection screen would maintain rigid support without detracting from the aesthetic visual qualities of the viewing area of the projection screen. The projection screen would be light-weight and would provide a thin bezel look. The projection screen would occupy less space and can be easily installed. The present embodiment accomplishes these objectives.

### SUMMARY OF THE INVENTION

To minimize the limitations found in the prior art, and to minimize other limitations that will be apparent upon the reading of the specifications, the preferred embodiment of the present invention provides an edge free fixed frame projection screen and a method of constructing the projection screen that avoids puncturing of the screen and provides a thin bezel look.

The present invention provides a projection screen assembly and a method of constructing the projection screen assembly. The projection screen assembly comprises a screen, a frame assembly and a mounting assembly. The screen has a front surface and a back surface. The front surface is configured to display data such as images, text or videos and the back surface includes a first Velcro means along a border thereon. The frame assembly has an outer surface and an inner surface with the inner surface having a channel and a second Velcro means adjacent to the channel. The channel being adaptable to receive a plurality of fastening means. The frame assembly includes a pair of horizontal frame members, a pair of vertical frame members, a plurality of connecting means, a plurality of tightening means and a support bar.

Each of the pair of horizontal frame members is connected to each of the pair of vertical frame members by means of the plurality of connecting means and the plurality of tightening means. Each of the pair of horizontal frame members has a pair of opposing ends having a plurality of holes thereon to receive the plurality of tightening means to connect with the connecting means. Similarly, each of the pair of vertical frame members has a pair of opposing ends having a plurality of slots thereon to receive the plurality of tightening means to connect with the connecting means to form the frame assembly. Each of the plurality of connecting means has a plurality of openings to receive the plurality of tightening means that connects together each of the pair of horizontal frame members with each of the pair of vertical frame members to form the rectangular frame assembly having a plurality of corners. The support bar is attached between the pair of horizontal frame members. The mounting assembly includes a plurality of brackets and a plurality of attachment means. The screen is positioned over the frame assembly to provide a frameless projection screen assembly that allows the use of multiple projection screen assembly without any gap therebetween and providing a thin bezel look.

A first objective of the present invention is to provide an edge free fixed frame projection screen assembly.

A second objective of the present invention is to provide a method of constructing the projection screen assembly that avoids puncturing of the screen.

A third objective of the present invention is to provide a projection screen assembly with a thin bezel look.

Another objective of the present invention is to provide a projection screen assembly that allows the use of multiple projection screen assembly without any gap therebetween.

A further objective of the present invention is to provide a projection screen assembly that provides a supporting structure which remains hidden from view to maintain a pleasing aesthetic appearance to the viewer.

Yet another objective of the present invention is to provide a projection screen assembly adaptable to provide a frame assembly which can be selectively assembled and disassembled in a simple and cost effective manner for ease of shipping, storage, and set up.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1A illustrates a perspective view of a frame assembly with one of a pair of horizontal frame members removed for clarity in accordance with the present invention;

FIG. 1B illustrates a front view of the frame assembly in accordance with the present invention;

FIG. 1C illustrates a front view of the frame assembly positioned on a screen in accordance with the present invention;

FIG. 1D illustrates a front view of the frame assembly attached with the screen by a Velcro means in accordance with the present invention;

FIG. 1E illustrates a front view of a support bar attached to the frame assembly and the screen in accordance with the present invention;

FIG. 1F illustrates a front view of the frame assembly attached with a plurality of brackets in accordance with the present invention;

FIG. 2 illustrates a perspective view of a projection screen assembly being mounted on a wall in accordance with the present invention;

FIG. 3A illustrates a rear perspective view of the projection screen assembly with a thin strip attached in accordance with one embodiment of the present invention;

FIG. 3B illustrates a front perspective view of the projection screen assembly with a plurality of thin strips attached in accordance with one embodiment of the present invention;

FIG. 4 illustrates a perspective view of a multiple projection screen assembly attached by means of a splicer in accordance with one embodiment of the present invention;

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

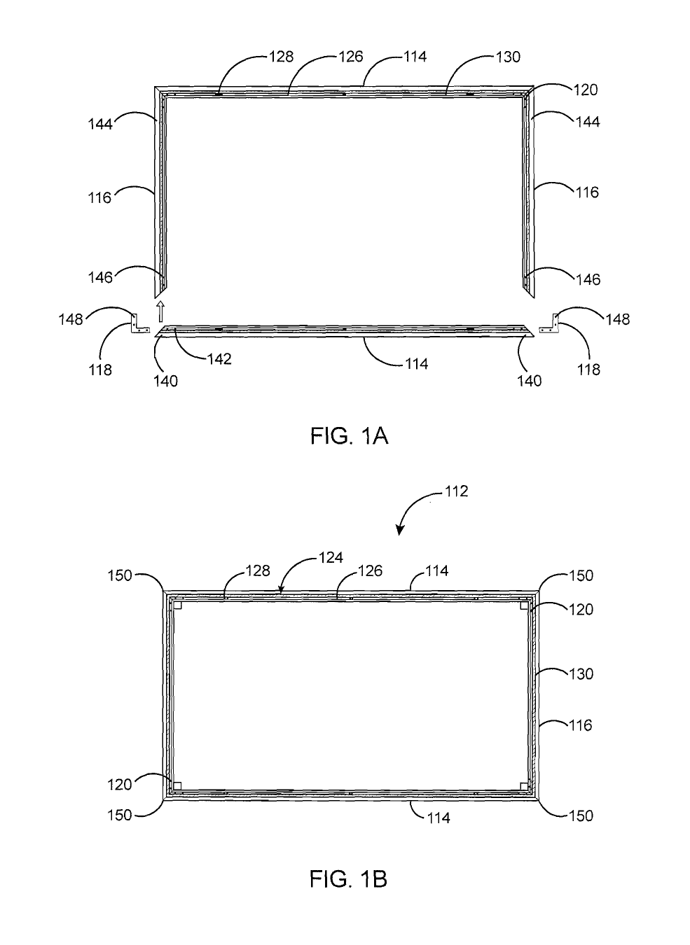

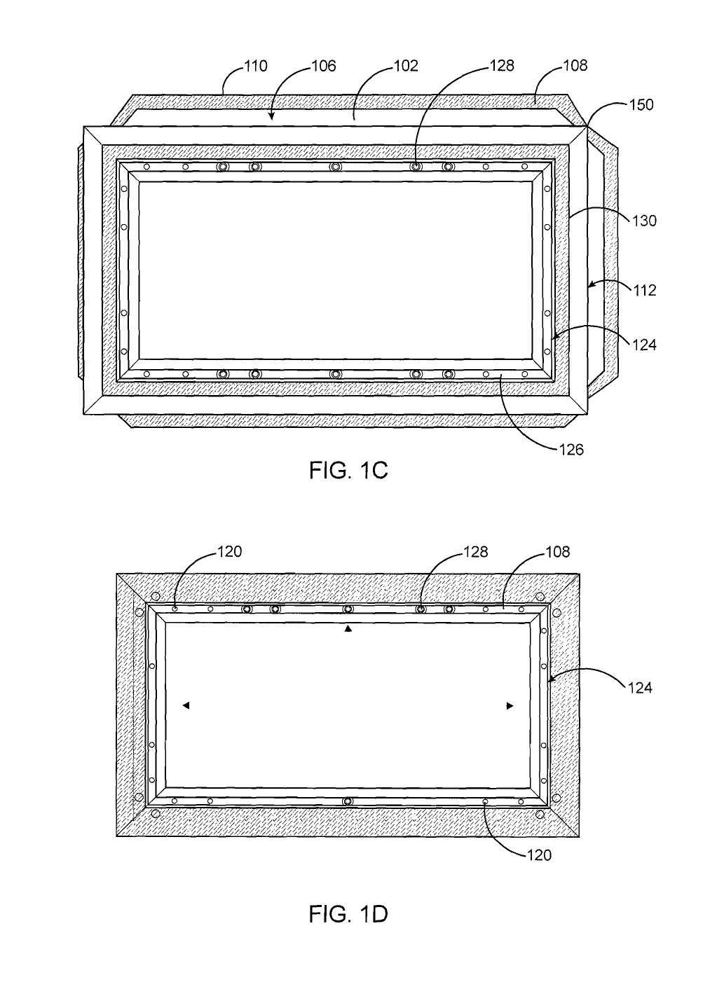

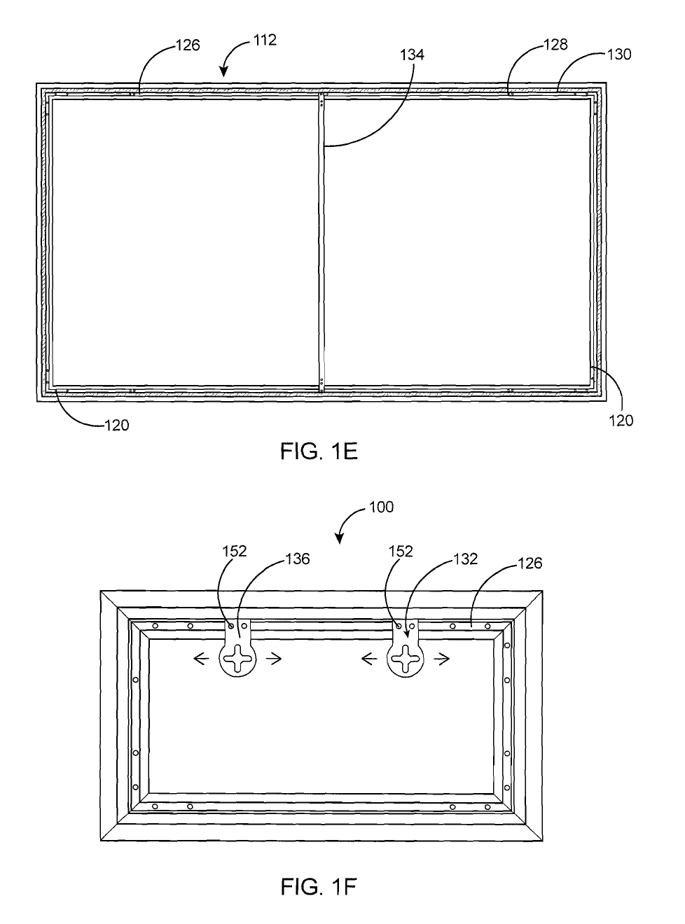

Referring to FIGS. 1A-1F, a projection screen assembly 100 and a method of constructing the projection screen assembly 100 is illustrated. The projection screen assembly 100 comprises a screen 102, a frame assembly 112 and a mounting assembly 132. The screen 102 has a front surface 104 and a back surface 106. The front surface 104 is configured to display data such as images, text or videos and the back surface 106 includes a first Velcro means 108 along a border thereon 110. The frame assembly 112 has an outer surface (not shown) and an inner surface 124. The inner surface 124 includes a channel 126 and a second Velcro means 130 adjacent to the channel 126. The channel 126 being adaptable to receive a plurality of fastening means 128. The fastening means can be screws and nuts. Preferably, the plurality of fastening means 128 can be M6*12 screws and M6 hex nuts. The frame assembly 112 includes a pair of horizontal frame members 114, a pair of vertical frame members 116, a plurality of connecting means 118, a plurality of tightening means 120 and a support bar 134. The pair of horizontal frame members 114 can be longer than the pair of vertical frame members 116 to provide a better vision of images displayed.

Each of the pair of horizontal frame members 114 is connected to each of the pair of vertical frame members 116 by means of the plurality of connecting means 118 and the plurality of tightening means 120 as illustrated in FIG. 1A. Each of the pair of horizontal frame members 114 has a pair of opposing ends 140 having a plurality of holes 142 thereon to receive the plurality of tightening means 120 to connect with the connecting means 118. Similarly, each of the pair of vertical frame members 116 has a pair of opposing ends 144 having a plurality of slots 146 thereon to receive the plurality of tightening means 120 to connect with the connecting means 118 to form the frame assembly 112 as shown in FIG. 1B. Each of the plurality of connecting means 118 has a plurality of openings 148 to receive the plurality of tightening means 120 that connects together each of the pair of horizontal frame members 114 with each of the pair of vertical frame members 116 to form the rectangular frame assembly 112 having a plurality of corners 150. The plurality of corners 150 do not have direct contact with the screen 102 to avoid puncturing of the screen 102 as illustrated in FIG. 1C. The support bar 134 is attached between the pair of horizontal frame members 114 that provide support to the frame assembly 112 and thereby provides a rigid projection screen assembly 100. The mounting assembly 132 includes a plurality of brackets 136 and a plurality of attachment means 138. The plurality of attachment means 138 can be a hollow wall anchor and a screw preferably, a M5*50 screw. The screen 102 is positioned over the frame assembly 112 to provide the frameless projection screen assembly 100 that allows the use of multiple projection screen assembly 100 without any gap therebetween and providing a thin bezel look.

The method for constructing the projection screen assembly 100 includes the following steps. Initially, at least one of a plurality of fastening means 128 is inserted into a channel 126 on each of a pair of horizontal frame members 114. Then each of the pair of horizontal frame members 114 is attached to each of a pair of vertical frame members 116 by means of at least one of a plurality of connecting means 118 and tightened with a plurality of tightening means 120 to form a frame assembly 112 having a plurality of corners 150 as illustrated in FIG. 1A and FIG. 1B. A screen 102 is laid completely flat with a front surface 104 facing down in a horizontal position. The frame assembly 112 is positioned on a back surface 106 of the screen 102 in such a way that the plurality of corners 150 does not come in direct contact with the screen 102 as illustrated in FIG. 1C. A border 110 of the screen 102 is folded over the frame assembly 112 and snapped in such a way that a first Velcro means 108 on the back surface 106 of the screen 102 coincides with a second Velcro means 130 on the frame assembly 112 as shown in FIG. 1D. A support bar 134 is positioned at the middle and attached between the pair of horizontal frame members 114 of the frame assembly 112 utilizing the plurality of fastening means 128 inserted in the channel 126 illustrated in FIG. 1E. A plurality of brackets 136 is attached with one of the pair of horizontal frame members 114 to hang the projection screen assembly 100 thus formed on a wall by means of a plurality of attachment means 138 illustrated in FIG. 1F. The plurality of fastening means 128 includes a screw and a nut. Folding the first Velcro means 108 on the border 110 of the screen 102 tightly over the second Velcro means 130 on the frame assembly 112 creates the projection screen assembly 100 having a thin bezel look. The screen can be removed from the frame assembly 112 by detaching the first Velcro means 108 on the back surface 106 of the screen 102 and the second Velcro means 130 and gently pulling back the screen 102 to unsnap from the frame assembly 112. By placing the frame assembly 112 on the back surface 106 of the screen 102 provides a frameless projection screen assembly 100 that allows the use of multiple projection screen assembly 100 without any gap therebetween.

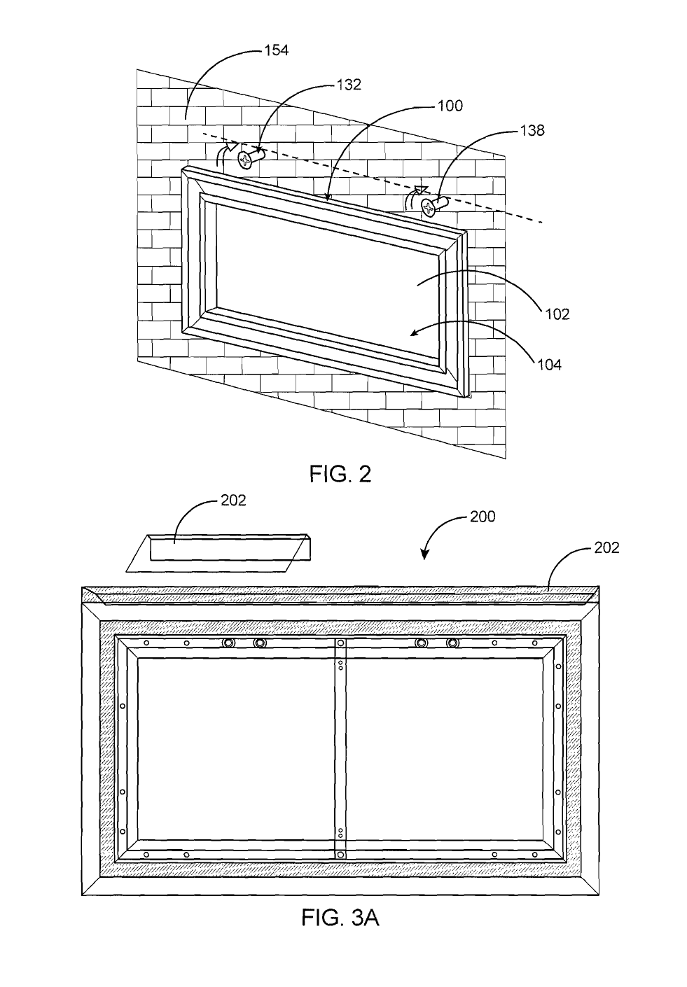

FIG. 2 illustrates a perspective view of the projection screen assembly 100 being mounted on a wall 154 in accordance with the present invention. The projection screen assembly 100 can be mounted on the wall 154 utilizing a plurality of attachment means 138. The plurality of attachment means 138 includes a wall anchor and a screw, preferably a wood screw. The plurality of brackets 136 is attached with one of the pair of horizontal frame members 114 by aligning a plurality of apertures 152 on each of the plurality of brackets 136 with the plurality of fastening means 128. Each of the plurality of brackets 136 is positioned to hang the projection screen assembly 100 in a straight horizontal position. In one embodiment, the plurality of brackets 136 can also be attached with the pair of vertical frame members 116 by positioning each of the plurality of brackets 136 on each of the pair of vertical frame members 116. The plurality of attachment means 138 is drilled into the wall 154 and the plurality of brackets 136 is slid into the plurality of attachment means 138 thereby holding the projection screen assembly 100 with the wall 154.

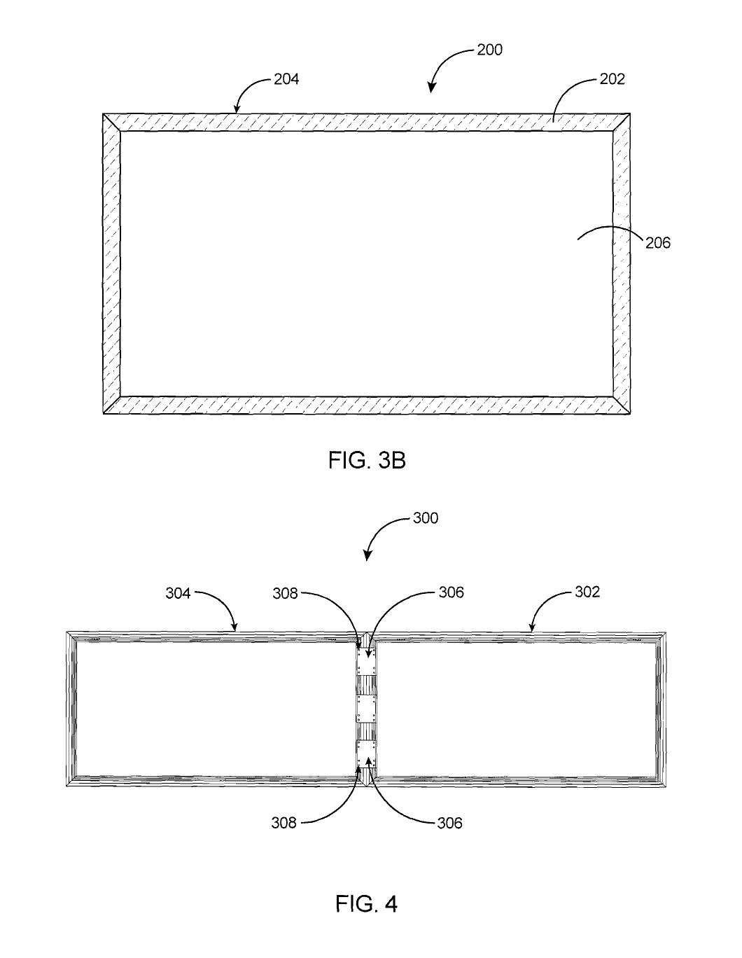

Referring to FIGS. 3A and 3B, a rear perspective view of a projection screen assembly 200 with a plurality of thin strips 202 attached in accordance with one embodiment of the present invention is illustrated in FIG. 4A. The plurality of thin strips 202 is employed to provide an elegant pencil thin bezel look for the projection screen assembly 200. The plurality of thin strips 202 has an inner layer (not shown) having an adhesive material. The plurality of thin strips 202 is aligned properly along the border of the projection screen assembly 200 and glued with the projection screen assembly 200 using the adhesive layer on the plurality of thin strips 202. Even though the projection screen assembly 200 is edge free and frame less, in this embodiment, the plurality of thin strips 202 creates an edge 204 on the front surface 206 of the projection screen assembly 200 as illustrated in FIG. 4B.

FIG. 5 illustrates a rear perspective view of a multiple projection screen assembly 300 attached by means of a plurality of splicers 306 in accordance with one embodiment of the present invention. In this embodiment of the present invention, a pair of projection screen assembly 302, 304 is connected together to form a bigger screen by means of the plurality of splicers 306 and a plurality of fastening means 308. Preferably, the fastening means 308 can be M6*12 screws and M6 hex nuts. This embodiment enables to connect a plurality of projection screen assemblies together without any gap therebetween providing a frameless projection screen assembly 100 with a thin bezel look.

What is claimed is:

1. A projection screen assembly, comprising:
a screen having a front surface and a back surface, the front surface configured to display data, the back surface includes a first Velcro means along a border thereon;
a frame assembly having a pair of horizontal frame members, a pair of vertical frame members, a plurality of connecting means, a plurality of tightening means and a support bar attached between the pair of horizontal frame members, each of the pair of horizontal frame members connected to each of the pair of vertical frame members by means of the plurality of connecting means and the plurality of tightening means, the frame assembly includes an outer surface and an inner surface, the inner surface having a channel adaptable to receive a plurality of fastening means and a second Velcro means; and
a mounting assembly having a plurality of brackets and a plurality of attachment means, the attachment means being utilized to attach the projection screen to a wall;
whereby the screen positioned over the frame assembly provides a frameless projection screen assembly that allows the use of multiple projection screen assembly without any gap therebetween and providing a thin bezel look.

2. The projection screen of claim 1 wherein each of the pair of horizontal frame members having a pair of opposing ends has a plurality of holes thereon to receive the plurality of tightening means.

3. The projection screen of claim 1 wherein each of the pair of vertical frame members having a pair of opposing ends has a plurality of slots thereon to receive the plurality of tightening means.

4. The projection screen of claim 1 wherein the channel on the frame assembly is adaptable to receive the plurality of connecting means.

5. The projection screen of claim 1 wherein each of the plurality of connecting means has a plurality of openings to receive the plurality of tightening means so as to connect together each of the pair of horizontal frame members with each of the pair of vertical frame members to form a rectangular frame assembly having a plurality of corners.

6. The projection screen of claim 5 wherein the plurality of corners do not have direct contact with the screen to avoid puncturing of the screen.

7. The projection screen of claim 1 wherein the first Velcro means on the back side of the screen coincides with the second Velcro means on the inner surface of the frame assembly to form the flat screen.

8. A projection screen assembly for use with a projector, the projector screen assembly comprising:
a screen having a front surface and a back surface, the front surface configured to display data and the back surface includes a first Velcro means along a border thereon;
a frame assembly includes an outer surface and an inner surface, the inner surface having a channel adaptable to receive a plurality of fastening means and a second Velcro means, the frame assembly comprising:
a pair of horizontal frame members having a pair of opposing ends with a plurality of holes thereon;
a pair of vertical frame members having a pair of opposing ends with a plurality of slots thereon;
a plurality of connecting means having a plurality of openings, the plurality of connecting means connect each of the pair of horizontal frame members with each of the pair of vertical frame members by means of a plurality of tightening means; and
a support bar attached between the pair of horizontal frame members; and
a mounting assembly having a plurality of brackets and a plurality of attachment means, the attachment means being utilized to attach the projection screen to a wall;
whereby the screen positioned over the frame assembly provides a frameless projection screen assembly that allows the use of multiple projection screen assembly without any gap therebetween and providing a thin bezel look.

9. The projection screen of claim 8 wherein the data includes images, videos or text.

10. The projection screen of claim 8 wherein the channel on the frame assembly is adaptable to receive the plurality of connecting means.

11. The projection screen of claim 8 wherein the plurality of holes on each of the pair of horizontal frame members, the plurality of slots on each of the pair of vertical frame members and the plurality of openings on the connecting means receives the tightening means and connects the pair of horizontal frame members with the pair of vertical frame members.

12. The projection screen of claim 8 wherein each of the pair of horizontal frame members connect with each of the pair of vertical frame members to form a rectangular frame assembly having a plurality of corners.

13. The projection screen of claim 12 wherein the plurality of corners do not have direct contact with the screen to avoid puncturing of the screen.

14. The projection screen of claim 8 wherein the first Velcro means on the back side of the screen coincides with the second Velcro means on the inner surface of the frame assembly to form the flat screen.

15. The projection screen of claim 8 wherein the fastening means includes a screw and a nut.

16. A method for constructing a projection screen assembly, the method comprising the steps of:
a) inserting at least one of a plurality of fastening means into a channel on each of a pair of horizontal frame members;
c) attaching each of the pair of horizontal frame members with each of a pair of vertical frame members utilizing at least one of a plurality of connecting means and tightening with a plurality of tightening means to form a frame assembly having a plurality of corners;
d) laying a screen completely flat with a front surface facing down in a horizontal position;
e) placing the frame assembly on a back surface of the screen in such a way that the plurality of corners do not come in direct contact with the screen;
f) folding a border of the screen over the frame assembly in such a way that a first Velcro means on the back surface of the screen coincides with a second Velcro means on the frame assembly.
g) positioning and attaching a support bar with the pair of horizontal frame members of the frame assembly utilizing the plurality of fastening means inserted into the channel; and
h) placing a plurality of brackets on at least one of the pair of horizontal frame members to hang on a wall by means of a plurality of attachment means.

17. The method of claim 16 wherein inserting at least one of the plurality of fastening means includes a screw and a nut.

18. The method of claim 16 wherein placing the frame assembly on the back surface of the screen provides a frameless projection screen assembly that allows the use of multiple projection screen assembly without any gap therebetween.

19. The method of claim 16 wherein folding tightly the first Velcro means on the border of the screen over the second Velcro means on the frame assembly creates a projection screen having a thin bezel look.
